(19) United States
(12) Patent Application Publication
(10) Pub. No.: US 2018/0336201 A1
(43) Pub. Date: Nov. 22, 2018

(54) Method and Apparatus for Generalized Sketch Ranking

(71) Applicant: VividCortex, Inc., Charlottesville, VA (US)

(72) Inventor: Preetam JINKA, Ashburn, VA (US)

(21) Appl. No.: 15/601,387

(22) Filed: May 22, 2017

(51) Int. Cl. G06F 17/30

(52) U.S. Cl. CPC G06F 17/3053; G06F 17/30864

(57) ABSTRACT

A sketch ranking method assigns hashes to items. The method, for each of multiple time intervals, receives for each item a value associated with the item, and identifies for each hash a maximum-valued item among the items covered by the hash. The method determines for each maximum-valued item a minimum aggregate value that would result from aggregating the values for the maximum-valued item across the multiple time intervals, and determines for each hash a maximum aggregate value that would result from aggregating the values for any item covered by the hash across the multiple time intervals. The method selects one of the minimum aggregate values as a threshold for eliminating hashes, eliminates each hash having a maximum aggregate value less than the threshold, and ranks a top-k items based only on values for items covered by hashes remaining after the hashes are eliminated.

### TECHNICAL FIELD

The present disclosure relates to efficient ranking of items based on values associated with the items.

### BACKGROUND

It is commonplace to rank the top k items among a set of N items, where N is greater than k, based on values associated with the items as observed or collected over a period of time. A conventional method of ranking aggregates the values for each item collected over the time period to produce an aggregate value for each item, and then ranks the items based on their aggregate values. Conventional ranking of large and complex data sets is resource intensive and slow.

### BRIEF DESCRIPTION OF THE DRAWINGS

FIG. 1 is a block diagram of an example system in which embodiments directed to sketch ranking may be implemented.

FIG. 2 is a flowchart of an example method of sketch ranking performed by a detection device.

FIG. 3 is an illustration of first example interval tables created for multiple time intervals in the sketch ranking method.

FIG. 4 is an illustration of first example interval sketches created for the multiple time intervals based on the first example interval tables in the sketch ranking method.

FIG. 5 is an illustration of a first example threshold ranking table created based on the first example interval sketches in the sketch ranking method.

FIG. 6 is an illustration of a first example hash ranking table created based on the first example interval sketches in the sketch ranking method.

FIG. 7 is an illustration of second example interval tables created for multiple time intervals in the sketch ranking method.

FIG. 8 is an illustration of second example interval sketches created for the multiple time intervals based on the second interval tables in the sketch ranking method.

FIG. 9 is an illustration of a second example threshold ranking table created based on the second example interval sketches in the sketch ranking method.

FIG. 10 is an illustration of a second example hash ranking table created based on the second example interval sketches in the sketch ranking method.

FIG. 11 is a block diagram of an example computer device or system representative of a detection device of FIG. 1 that performs sketch ranking.

FIG. 12 is a screen shot that shows query groups ranked by total execution time.

### DESCRIPTION OF EXAMPLE EMBODIMENTS

### Overview

An efficient sketch ranking method assigns hashes to uniquely identifiable items associated with operating a host computer device over multiple time intervals. The method, for each time interval, receives for each item a respective value of a variable associated with the item and that results from operating the host computer device during the time interval, and identifies for each hash a respective maximum-valued item among the items covered by the hash as the item for which a maximum value is received. The method determines for each maximum-valued item a respective minimum aggregate value that would result from aggregating the values for the maximum-valued item across the multiple time intervals, and determines for each hash a respective maximum aggregate value that would result from aggregating the values for any item covered by the hash across the multiple time intervals. The method selects one of the minimum aggregate values as a threshold for eliminating hashes, eliminates each hash having a maximum aggregate value less than the threshold, and ranks a top-k items of the items based only on values for items covered by hashes remaining after the hashes are eliminated.

### Example Embodiments

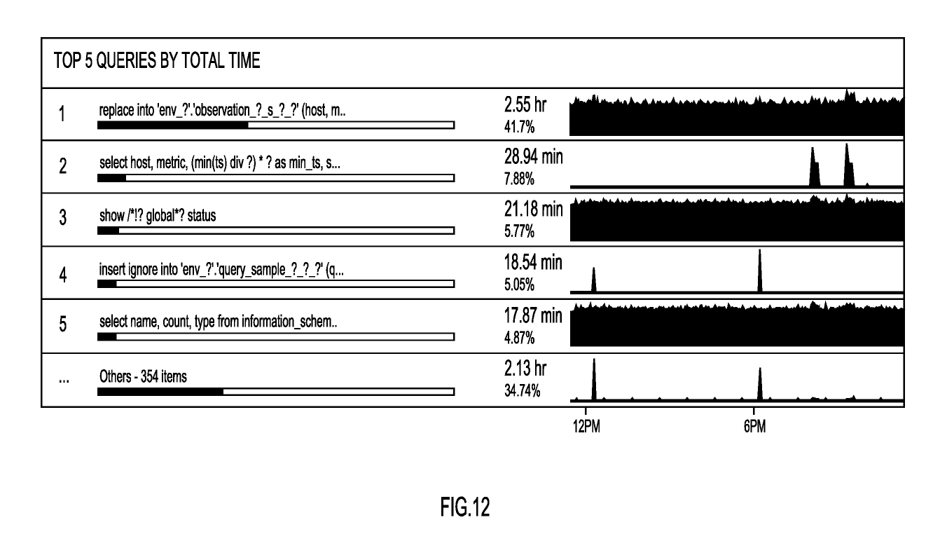

This document considers ranking as answers to queries of the form “what are the top N items for category C during time range R ordered by metric M?” For example, a query could be “what are the top 10 query identifiers among all queries during the past day ordered by total time?” An example of a ranking is shown in FIG. 12, which is an example screenshot showing query groups ranked by total execution time.

In order to generate this ranking, queries similar to the following SQL may be performed:

```
SELECT id, SUM(time) AS total_time FROM observations
      GROUP BY id
      ORDER BY total_time DESC;
```

A conventional implementation used to implement the ranking associated with this type of query fully materializes and aggregates rows, sorts all groups, and throws away all but the requested top-k of the groups. The work associated with sorting all groups can become resource-intensive because it has to be done with access to the entire data set. For reasonable latency, this data set also has to be fast to access.

There are reasons why the conventional implementation is not practical. Interactive queries, which are user-generated and require low latency, may require sorting in random access memory (RAM) for performance, but the data set may be too large to fit in RAM on a single machine. It may be possible to spread that data set onto multiple machines, but network speeds may be too slow for interactive queries. Finally, the data set may not be readily available. If data are in cold storage, accessing the entire data set would also be too slow for interactive queries.

Accordingly, embodiments presented herein are directed to ranking queries efficiently. The embodiments use sketch data structures in order to reduce the amount of data processed and/or transferred during the “sketch” ranking. The embodiments use hash functions, the sketch data structures, and a technique called early pruning to eliminate insignificant elements in early stages of ranking a query, so as to avoid accessing data that is not needed to generate an accurate ranking.

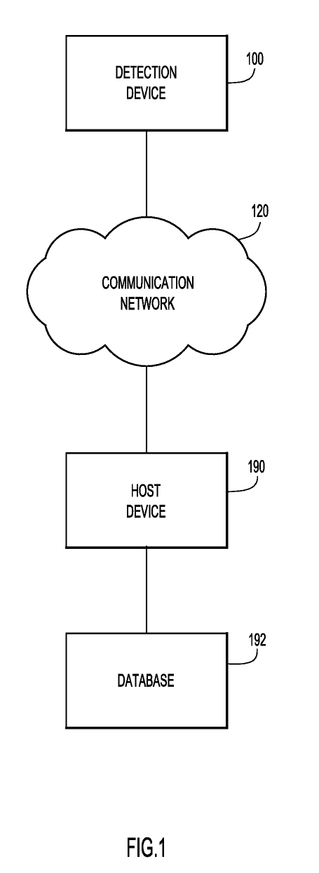

With reference to FIG. 1, there is a block diagram of a detection device/apparatus 100 configured to observe operation of a host device 190 (sometimes referred to as a processing system, and/or as an operational entity). Host device 190 may be any suitable entity being observed including, but not limited to, another device, apparatus, system, process, a thread executing within a process, and/or the like, including any subcomponent (e.g., a sub-system) thereof. The observed operation may be any operational aspect of host device 190, such as database performance metrics, and/or the like. For example, host device 190 includes and/or is otherwise communicably coupled to a database 192, and the host device 190 can be configured to observe operation of the database 192.

Examples of host device 190 include, but are not limited, to a server, a compute device, a router, a data storage device, a tablet, a mobile device, and/or the like. Host device 190 may include computer software (stored in and/or executed at hardware) such as a web application, a database application, a cache server application, a queue server application, an operating system, a file system, and/or the like; computer hardware such as a network appliance, a storage device (e.g., disk drive, memory module), a processing device (e.g., computer central processing unit (CPU)), a computer graphic processing unit (GPU), a networking device (e.g., network interface card), and/or the like; and/or combinations of computer software and hardware (e.g., assembly line, automatic manufacturing process). In some instances, although not shown in FIG. 1, the detection device 100 can be operatively coupled to more than one host device or other devices, such that the detection device 100 can substantially simultaneously observe (e.g., to detect anomalies) more than one system and/or process according to instances described herein.

With respect to host device 190, the above-mentioned observed operation generates, is controlled by, and/or is otherwise associated with one or more observable parameters, observable values of variables, and/or the like. In such instances, observing the operation can include measuring, estimating, monitoring, analyzing, and/or receiving a value associated with the variable(s). In some instances, computation can be performed on the received variable value(s) to further analyze the operation. In some instances, each observation value includes an identifier associated with the host device 190, an indication of the performance metric of the host device 190 (including a specification of the performance metric as listed above, or the value of the performance metric, or both), and an indication of the predetermined time period associated with that observation value. Other examples of variables/metrics include a throughput time metric for a query or a database, and an execution time metric for a query or a database. In some instances, each observation value can include an indication of a host identifier associated with host device 190 (e.g., a MAC address of the host device 190), the number of times Internet Protocol (IP) addresses are accessed via a network; an indication of a metric identifier, an indication of a category identifier (e.g., associated with a predetermined pattern), an indication of a timestamp, and/or an indication of a value of the performance metric. For additional context, further examples of observed values are provided below after the description of FIG. 7.

Detection device 100 may be any device with data processing and computing capabilities including, but not limited to, a workstation, a compute device, a tablet, a mobile device, and/or the like. Detection device 100 may be operatively coupled to host device 190 via, for example, a network 120. The network 120 can be any type of network that can operatively connect and enable electronic transmission between the detection device 100 and the host device 190. Network 120 may include one or more wide area networks (WANs), such as the Internet, and or more local area networks (LANs).

As will be described in detail below, sketch ranking performed by detection device 100 ranks uniquely identifiable “items” according to observed “values” of “variables” associated with the items. It is understood that the generalized terms “items,” “values,” and “variables” take on specific meaning depending on the context or scenario in which a specific sketch ranking is performed. For example, in one scenario, a client device accesses server devices at various IP addresses over a network, and it is desired to sketch rank the IP addresses according to a total number of times each IP address is accessed over successive time intervals. The total number of times each IP address is accessed is referred to as a “hit count.” In that scenario, the IP addresses represent uniquely identifiable “items,” and the hit count represents a “variable” or metric associated with the uniquely identifiable items and that takes on different “values” in each time interval.

In another example, a processor may execute many differently named processes, and it is desired to sketch rank the processes according to how many times they are executed/how long their execution times are over successive time intervals. In that scenario, the different processes represent uniquely identifiable “items,” and the number of execution times/execution time represent “variables” associated with the processes and that take on different “values” across the successive time intervals. In both example scenarios, the uniquely identifiable items may be ranked based on an accumulation of the values that the variable takes on for each of the identifiable items across the time intervals.

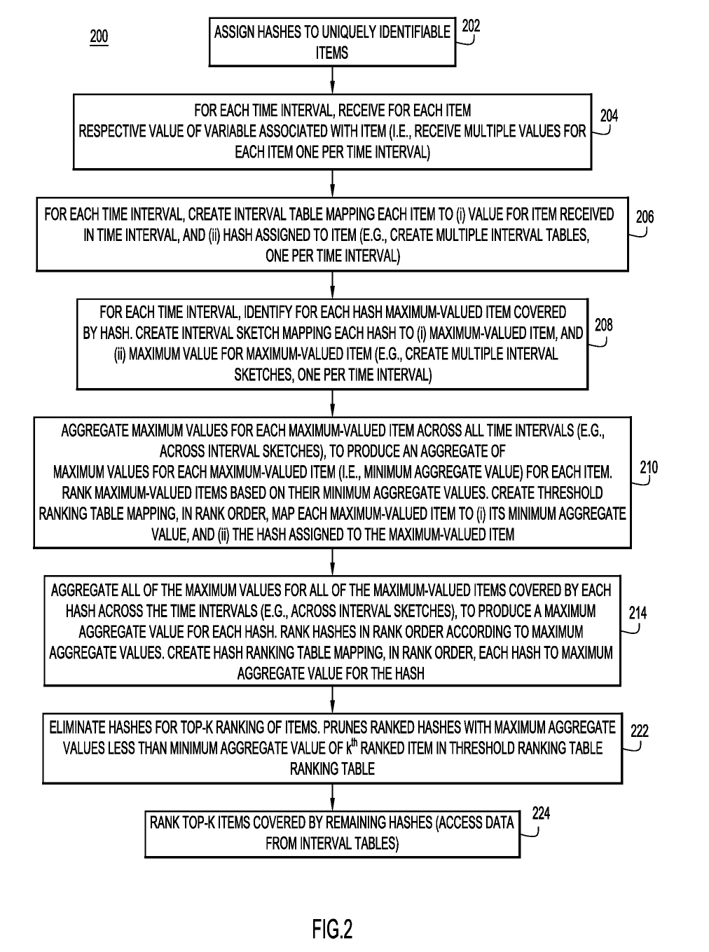

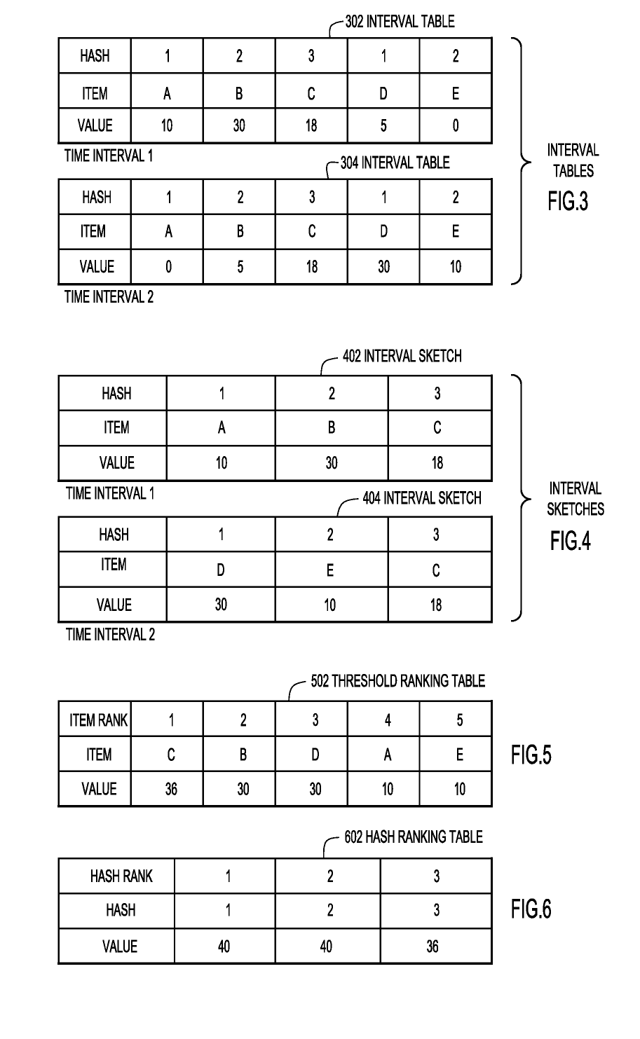

With reference to FIG. 2, there is a flowchart of a method of generalized sketch ranking of uniquely identifiable items assigned to hashes according to observed values (i.e., “values”) of variables associated with the items, performed by detection device 100. FIG. 2 is described also with reference to FIGS. 3-6, and then with reference to FIGS. 7-10, which show illustrations of example data structures in the form of tables that are created in the method 200 based on an example sets of values, as described below.

At 202, detection device 100 assigns hash values (referred to as simply “hashes”) to uniquely identifiable items. Hash values are assigned to items for the purpose of mapping a relatively large number of items into a significantly smaller number of hashes. The hashing operation is designed such that individual hash values are not necessarily unique to specific items. As a result, several different items may receive the same hash value and are thereby grouped together under a single hash. By grouping a substantial number of items into a more manageable number of hashes, the ranking methodology can take advantage of the efficiency of performing certain operations on a relatively small number of hashes instead of each individual item.

The overall objective of the methodology is to quickly eliminate or “prune” a large number of items from consideration in the ranking process by eliminating (pruning) entire hashes from consideration and, thereby, all of the items within those hashes. This can be accomplished by ranking the hashes and then eliminating the lower ranking hashes. One practical difficulty, however, is in determining which lower-ranking hashes (and hence their items) can safely be eliminated while ensuring that all of the high-ranking items are not within those hashes. The methodology enables unnecessary hashes and their items to be eliminated from consideration in the item ranking process, while ensuring that no hashes containing any of the top k ranking items are improperly eliminated.

More specifically, each item may be uniquely identified by a unique identifier associated with that item. Detection device 100 assigns the hashes so that each item maps to only one hash value (referred to as simply a “hash”) and each of at least some of the hashes covers multiple items. Detection device 100 may assign the hashes using any known or hereafter developed hash function that uniformly distributes the hashes across the identifiers of the items (and thus across the items). In an example with 1000 items and 10 hashes, the hash function assigns each hash so that the hash covers approximately 10 different items.

At 204, for each of multiple successive time intervals or ranges, detection device 100 receives/access for each item a respective value of a variable associated with the item and the identifier of the item. In other words, detection device 100 receives/accesses multiple respective values for each item, one per time interval. In some scenarios, detection device 100 may receive multiple “sub-values” of the variable associated with an item in a given time interval. In such a scenario, detection device accumulates the multiple sub-values to produce a cumulative sub-value that represents the value for the time interval.

At 206, for each time interval, detection device 100 creates and stores a respective interval values table (referred to as simply an “interval table”) having entries that map each item to (i) the respective value for the item accessed/received in that time interval, and (ii) the hash assigned to the item. As a result, detection device 100 creates and stores multiple interval tables, one per time interval. Operation 206 maps, for each time interval, each item to its respective value and assigned hash.

With reference to FIG. 3, there is an illustration of example interval tables 302 and 304 created by operation 206 for successive time intervals, time interval 1 and time interval 2, respectively. Interval table 302 includes a top row “Hash” listing hashes (e.g., hashes 1, 2, and 3), a middle row “Item” listing items (e.g., by identifiers A-E), and a bottom row “Value” listing values associated with each item as accessed in time interval 1. Each of the columns of interval table 302 maps a corresponding item to its associated value and the hash assigned to, or that covers, the item. For example, the first column maps item A (i.e., the item associated with identifier A) to its value 10 and hash 1 assigned to item A. Table 302 reveals that hash 1 covers two items A and D, hash 2 covers two items B and E, and hash 3 covers only 1 item C. Interval table 304 is arranged similarly to interval table 302 and, therefore, the description of interval table 302 shall suffice for interval table 304.

Returning to FIG. 2, at 208, for each time interval, detection device 100 identifies for each hash a maximum-valued or “top” item among the items covered by the hash as the item having a maximum or top value among all of the items covered by the hash. Detection device 100 creates and stores a respective interval “sketch” per interval having entries that map each hash to (i) the maximum-valued item covered by the hash, and (ii) the maximum value for the maximum-valued item. As a result, detection device 100 creates and stores multiple interval sketches, one per time interval. The multiple interval sketches may be thought of as a single larger sketch that is partitioned into the separate time intervals. Operation 208 maps, for each time interval, each hash to the maximum-valued item covered by the hash, and the maximum value for that item. Examples of data structures used to implement each of the interval sketches include, but are not limited to, Count-Min sketches.

A sketch may be thought of as a data structure including multiple storage locations or “buckets,” one per hash. The goal is to implement the sketch so that each bucket stores a highest-valued (i.e., maximum-valued) item covered under the hash for that bucket. Within each time interval, the sketch essentially ignores all but the highest-valued item within each hash. Thus, for example, in a hash that groups 50 items together, in each time interval, the sketch includes only the highest-valued item (and its actual value) and ignores the other 49 items and their values. In general, detection device 100 implements the sketch in the following manner. Initially each bucket is empty. When detection device 100 receives a new value for an item assigned to a given hash, the detection device hashes the identifier for the item to a location of the bucket for the given hash using the hash function mentioned above in connection with operation 202. Then, detection device 100 checks the content of the bucket for the given hash. If the bucket is empty, detection device 100 stores the new value in the bucket. If the bucket is not empty, detection device 100 determines whether the new value is greater than the value stored in the bucket. If the new value is greater, detection device 100 overwrites the stored value with the new value and also stores the identifier of the new item (e.g., the detection device stores the tuple {item identifier, item value} in the bucket), otherwise the detection device discards the new value. This process is repeated each time a new value arrives for an item within the hash. Over time, each bucket becomes populated with the tuple for the highest-valued item for the hashes corresponding to the bucket. Thus, the sketch is an efficient way to search for and store the highest-valued items.

With reference to FIG. 4, there is an illustration of example interval sketches 402 and 404 created by operation 208 for successive time intervals, time interval 1 and time interval 2, respectively. Interval sketch 402 includes a top row “Hash” listing hashes (e.g., 1, 2, and 3), a middle row “Item” listing maximum-valued items (e.g., by identifiers A, B, and C) identified for each hash in the interval 1, and a bottom row “Value” listing the maximum values (e.g., 10, 30, and 18) associated with each maximum-valued item. The columns of interval sketch 402 each map a corresponding hash to its associated maximum-valued item and maximum value. Interval sketch 404 is configured similarly to interval sketch 402 and, therefore, the description of interval sketch 402 shall suffice for interval sketch 404.

The interval table and the interval sketch for the same time interval are populated with consistent information For example, a comparison between interval table 302 and interval sketch 402 reveals that the interval sketch maps each hash (e.g., 1, 2, or 3) to the maximum-valued item (e.g., A, B, or C) covered by the hash and the maximum value (e.g., 10, 30, and 18) as consistently shown in the interval table. For example, interval table 302 shows that hash 1 covers both items A and D with values 10 and 5, respectively, while sketch table 402 maps hash 1 to maximum-valued item A and (maximum) value 10 among the items A and D.

Returning again to FIG. 2, at 210, detection device 100 aggregates (e.g., sums) the per interval maximum values for each maximum-valued item across all of the time intervals (e.g., across all of the interval sketches), to produce an aggregate of maximum values for each maximum-valued item from the sketches. The aggregate of maximum values is also referred to as the “minimum aggregate value,” for reasons described below. This operation focuses on the maximum-valued items and their maximum values in the interval sketches, while essentially ignoring the hash assignments of the items. Stated another way, the interval sketches are organized by hashes such that, in each time interval, the interval sketch includes only one value per sketch, namely, the value of the highest-valued item within the hash during the time interval. Nevertheless, since the identity of the item with the highest value in each hash in each interval is preserved by the sketches, in the aggregation operation, values can be aggregated by item in this operation, and not by hash.

Detection device 100 ranks the maximum-valued items from top to bottom (in a descending order), referred to as a maximum-valued items ranking order, according to their associated minimum aggregate values. Detection device 100 creates and stores a threshold ranking table (or simply a “threshold table”) having entries that map, in the maximum-valued items rank order, each maximum-valued item to (i) its minimum aggregate value, and (ii) the hash assigned to the maximum-valued item.

Each aggregate of maximum values for the associated item represents the minimum aggregate value for the item because an aggregate of all of the values for the item across all of the time intervals (i.e., a “complete” or “total” aggregate value for the item that takes into account the full data set), will be at least, and thus not less than, the aggregate of maximum values for the item. In other words, while each aggregate of maximum values for the associated item incorporates only a subset of the full data set, it does include at least the maximum values associate with the item that would necessarily be included in the complete aggregate, such that the aggregate of maximum values represents the minimum (complete) aggregate value. The aggregate value for each item includes only the values for that item from the time intervals in which that item happened to have the highest value within its hash and excludes the values for that item from time intervals in which that item did not have the highest value among the items in the hash. Consequently, the aggregate value for each item is, in general, less than the aggregate value for that item that would result from summing the values of that item from all of the time intervals. In summary, operation 210 advantageously determines for each maximum-valued item a respective minimum aggregate value that can/would result from aggregating the all of values for that maximum-valued item across all of the time intervals over which the values are collected, without actually aggregating all of the values across all of the time intervals. This saves computation time and expense.

In terms of ranking items according to their aggregate values, the k^{th} aggregate of maximum values in the threshold ranking table (i.e., the aggregate of maximum values that is k positions from the top position) is referred to as the minimum aggregate value for the k^{th} item, where the label “k^{th}” means k items from the top. The minimum aggregate value for the k^{th} item sets a lower bound on the values that items in the top-k items may have. To reduce computational complexity/loading in subsequent ranking of the top-k items, the minimum aggregate values may be used as minimum thresholds to prune or eliminate hashes and their covered items from consideration in the value-ranking.

With reference to FIG. 5, there is an illustration of an example threshold ranking table 502 created in operation 210 from interval sketches 402 and 404. Threshold ranking table 502 includes a top row “Rank” listing item rankings from top to bottom (e.g., ranks 1, 2, 3, 4, and 5, where 1 is top and 5 is bottom), a middle row “Item” listing maximum-valued items (e.g., items C, B, D, A, and E) in their maximum-valued items ranking order, and a bottom row “Value” listing the aggregate of maximum values (i.e., minimum aggregate value) associated with each maximum-valued item. The columns of table 502 each map a corresponding rank (e.g., 1) to (i) the maximum-valued item (e.g., C) with that rank, and (ii) the associated aggregate of maximum values (i.e., minimum aggregate value) (e.g., 36) for the maximum-valued item. In a given column of threshold ranking table 502 (e.g., the first column), the value (e.g., 36) of the item (e.g., C) listed in that column represents the sum of the values for that same item taken from (i) interval sketch 302 (e.g., value 18 for item C in the third column), and (ii) interval sketch 304 (e.g., value 18 for item C in the third column). Note, for example, that the highest ranking item is “C” with a value of 36. This value happens to match the sum of the values of item C from both time intervals (18+18) because item C happened to be the highest-valued item in its hash (hash 3) in both time intervals. Contrast that result with the result for item B, whose values from both time intervals sum to 35 (30+5) but nevertheless has a value of 30 in the threshold ranking table in FIG. 5. This lower value results from the fact that the value of item B in the second time interval was not the highest value within its hash (item E had a higher value of 10) and therefore was not counted in this aggregation process.

Returning again to FIG. 2, at 214, detection device 100 aggregates (e.g., sums) all of the maximum values for all of the maximum-valued items covered by each hash across the time intervals (e.g., all of the interval sketches), to produce a maximum aggregate value for each hash. This operation focuses on the hashes and maximum values in the interval sketches. Detection device 100 ranks the hashes from top to bottom in a hash ranking order according to their maximum aggregate values. Note that because the aggregated values for each hash are summed from its highest-valued item in each time interval, the aggregated value for each hash is certain to be at least as great as the complete aggregate value of the highest value item within the hash. In other words, one can be certain that the aggregate value across the time intervals for any item within a hash will not exceed the sum of the highest values from each of the time intervals for that hash, so the aggregate value of every item in the hash will be less than or equal to the sum of the hash's maximums. Detection device 100 creates and stores a hash ranking table having entries that map hash rankings each to (i) a corresponding hash with that rank, and (ii) the maximum aggregate value for the hash. In other words, the hash ranking table maps, in the hash ranking order, each hash to the maximum aggregate value for the hash. The maximum aggregate value for each hash determines the maximum aggregate value any single item covered by that hash (which typically covers multiple items) can have. This is because each maximum aggregate value represents a sum of the maximum values for all of the items covered by the hash across all of the time intervals, such that no single item covered by the hash can contribute an aggregate value greater than the maximum aggregate value for the hash. In summary, operation 214 advantageously determines for each hash a respective maximum aggregate value that can/would result from aggregating the values for any item covered by the hash across the multiple time intervals, without actually aggregating all of the values of each item covered by the hash across all of the time intervals. This saves computation time and expense.

Consider an example in which a hash covers items A and B, and values for items A and B are collected over 10 time intervals. In one example, item A contributes maximum values across all 10 time intervals. The sum of the 10 maximum values for A will be equal to, not greater than, the maximum aggregate value. In another example, item A contributes maximum values in 8 time intervals, and item B contributes maximum values in 2 intervals. The maximum aggregate value is the sum of the 8 maximum values for item A and the 2 maximum values for item B. The sum of the 8 values for A is less than the maximum aggregate value, and the sum of the 2 values for item B is also less than the maximum aggregate value. Further examples of this concept can be seen in a comparison of the item-value information in interval tables 302 and 304 against the item-aggregate maximum values information in a hash ranking table described below in connection with FIG. 6.

With reference to FIG. 6, there is an illustration of an example hash ranking table 602 created in operation 214 from interval sketches 402 and 404. Hash ranking table 602 includes a top row “Rank” listing hash rankings from top to bottom (e.g., ranks 1, 2, and 3, where 1 is top and 3 is bottom), a middle row “Hash” listing hashes (e.g., hashes 1, 2, and 3, not be confused with “ranks 1, 2, and 3” enumerated in the top row) in their maximum-valued items ranking order, and a bottom row “Value” listing the maximum aggregate value associated with each hash. The columns of table 602 each map a corresponding hash ranking (e.g., hash ranking 1) to (i) the hash with that rank (e.g., hash 1) and (ii) the maximum aggregate value for that hash (e.g., 40). In a given column of hash ranking table 602 (e.g., the first column), the aggregate maximum value (e.g., 40) for the hash (e.g., 1) listed in that column represents the sum of the maximum values for that same hash taken from (i) interval sketch 302 (e.g., value 10 for item A in the first column), and (ii) interval sketch 304 (e.g., value 30 for item D in the first column).

Returning again to FIG. 2, at 222, as a pre-cursor to performing a top-k ranking of the items, detection device 100 prunes or eliminates hashes (and thus the items assigned to those hashes) that will not contribute to the top-k ranking, based on information from the threshold ranking table from operation 210 (e.g., threshold ranking table 502) and the hash ranking table from operation 214 (e.g., hash ranking table 602). More specifically, in order to prune the hashes, detection device 100 determines which hashes will not contribute to the top-k ranking based on the following information:
a. The minimum aggregate value for the k^{th} item from the threshold ranking table.
b. The maximum aggregate value for each hash from the hash ranking table.

As mentioned above, the minimum aggregate value for the k^{th} item sets the lower bound on what values items in the top-k ranking may have, while the maximum aggregate value for each hash determines the maximum aggregate value any single item within that hash can have. Detection device 100 prunes all hashes with maximum aggregate values less than the minimum aggregate value of the k^{th} item because it is not possible for any item within those hashes to have a high enough (aggregate) value to propel the item into the top-k items. This ensures that the top-k items will be represented in the remaining hashes that have not be pruned in operation 222.

With reference again to threshold ranking table 502 and hash ranking table 602, in an example of a top-1 ranking, detection device 100 uses minimum aggregate value 36 for 1^{st} item C from table 602 to prune any of hashes 1, 2, and 3 in table 602 having a maximum aggregate values less than minimum aggregate value of 36. Because, in this example, all of the hashes have maximum aggregate values equal to or above 36, none of the hashes are pruned. In other cases, however, one or more of the hashes may be pruned.

At 224, after the bottom hashes have been pruned, i.e., after detection device 100 has determined a subset of the hashes representing the top hashes, the detection device performs a final ranking of the top-k items, which are assured to be in the top hashes. To do this, detection device 100 ranks the items covered by the remaining hashes (which indicate the remaining items to be ranked). Detection device 100 may access the values of the remaining items with which to perform the ranking of the top-k items among the remaining items from the interval tables accessed in operation 204. In an example, detection device 100 may issue a ranking query using additional information to filter out unnecessary rows, e.g. using a WHERE clause in SQL:

```
SELECT id, SUM(time) AS total_time FROM observations
      WHERE HASH(id) IN ( /* ... top hashes ... */ )
      GROUP BY id;
```

Detection device 100 may generate for display interactive user interfaces (UIs) to facilitate interaction of a user with sketch ranking method 200. In one example, a UI may include a user selectable option allowing a user to select a time range over which a sketch ranking is to be performed. For example, the option may list the time intervals as selectable options.

Method 200 is now described briefly in connection with FIGS. 7-01, which are similar to FIG. 3-6, respectively. More specifically, FIGS. 7-10 show illustrations of example tables that are created in method 200 based on a set of example values for items A-E under hashes 1-3 collected over time intervals 1 and 2 and that are slightly different from the corresponding values introduced in the example tables of FIGS. 3-6. These different values generate different hash rankings and thus different hash eliminations.

FIG. 7, similar to FIG. 3, shows example interval tables 702 and 704 created by operation 206 for successive time intervals, time interval 1 and time interval 2, respectively. The item values stored in interval table 702 are the same as those stored in interval table 302, but the item values stored in interval table 704 are slightly different from those stored in interval table 304. Specifically, the value for item C stored in interval table 704 is 24, while the value for item C stored in interval table 304 is 18.

FIG. 8, similar to FIG. 4, shows example interval sketches 802 and 804 created by operation 208 for the item values stored in interval tables 702 and 704 for successive time intervals, time interval 1 and time interval 2, respectively. Sketch table 802 is the same as sketch table 402, but sketch table 804 is slightly different from sketch table 404 because of the increase in the value of item C to 24 in interval table 704. As a result, in sketch table 804, the maximum value for maximum-valued item C is also 24.

FIG. 9, similar to FIG. 5, shows example threshold ranking table 902 created in operation 210 from interval sketches 802 and 804. The increase of the maximum value of maximum-valued item C to 24 in interval sketch 804 results in a corresponding increase of the minimum aggregate value for maximum-valued item C to 42 in thresholds ranking table 902. The value 42 represents the aggregate of maximum values 18 and 24 for maximum-valued item C from interval sketches 802 and 804.

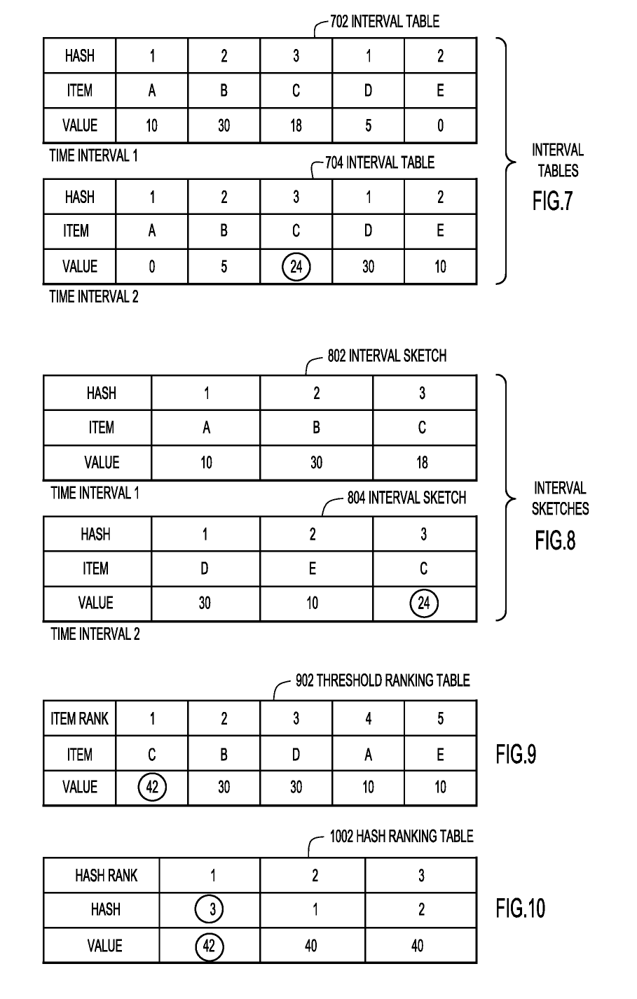

FIG. 10, similar to FIG. 6, shows an example hash ranking table 1002 created in operation 214 from interval sketches 802 and 804. The increase of the maximum value of maximum-valued item C to 24 in interval sketch 804 results in a corresponding increase of the maximum aggregate value for hash 3 to 42 (due to the increase in maximum-valued item C) in hash ranking table 1002. This permutes the ranking of hashes 1-3 relative to the ranking in table 602. Specifically, hash 3 is now the top-ranked hash based on its corresponding maximum aggregate value of 42.

In order to prune the hashes in hash ranking table 1002 for a subsequent top-k ranking, detection device 100 selects the minimum aggregate value from threshold ranking table 902 as a minimum threshold to eliminate hashes that will not contribute items to the top-k ranking. In an example of a top-1 ranking, detection device 100 selects the 1^{st} ranked minimum aggregate value from table 902 as a minimum threshold with which to prune any of hashes 1, 2, and 3 in table 1002, that is, detection device 100 selects minimum aggregate value 42 for 1^{st} maximum-valued item C. Then, detection device 100 eliminates hashes having a maximum aggregate values less than the minimum threshold, i.e., less than minimum aggregate value 42. Because, in this example, hashes 1 and 2 have maximum aggregate values less than the minimum threshold 42, hashes 1 and 2 are pruned. Then, detection device 100 performs top-1 ranking using only items from remaining hash 3, i.e., only item C. Thus, relative to the example tables shown in FIGS. 3-6, the increase in the value of item C from 18 to 24 in the second time interval, time interval 2, adjusts the values of the ranked minimum thresholds in threshold ranking table 902 and permutes the ranking of the hashes in hash ranking table 1002, which results in a different hash pruning decision.

In the description above, various data structures, including the interval tables, the interval sketches, the threshold ranking table, and the hash ranking table are presented as tables having rows and columns by way of example only. It is understood that those data structures may be configured in accordance with any known or hereafter developed data structure/data structure schema used for storing and accessing information.

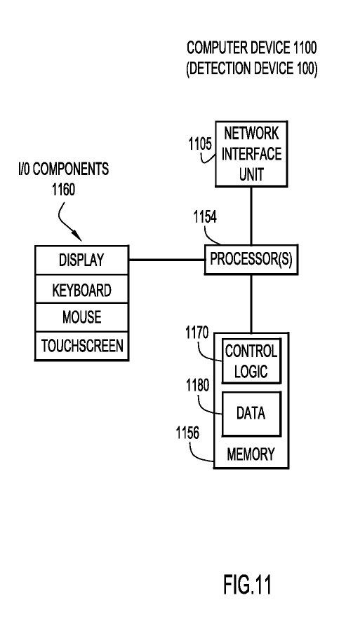

With reference to FIG. 11, there is a block diagram of a computer device or system 1100 representative of detection device 100. Computer device 1100 includes a network interface unit 1105 to communicate with a wired and/or wireless communication network, a processor 1154 (or multiple processors), and memory 1156. Network interface unit 1105 may include an Ethernet card with a port (or multiple such devices) to communicate over wired Ethernet links and/or a wireless communication card with a wireless transceiver to communicate over wireless links.

The memory 1156 stores instructions for implementing sketch ranking methods described herein. Computer device 1100 also includes input/output (I/O) components 1160 connected with processor 1154 including a display for displaying information, and input components, such as a keyboard, mouse, touchscreen, and the like, through which a user may enter information into the computer device.

The memory 1156 may comprise read only memory (ROM), random access memory (RAM), magnetic disk storage media devices, optical storage media devices, flash memory devices, electrical, optical, or other physical/tangible (non-transitory) memory storage devices. The processor 1154 is, for example, a microprocessor or a microcontroller that executes instructions stored in memory. Thus, in general, the memory 1156 may comprise one or more tangible computer readable storage media (e.g., a memory device) encoded with software comprising computer executable instructions and when the software is executed (by the processor 1154) it is operable to perform the operations described herein. Memory 1156 stores control logic 1170 to perform the sketch ranking methods described herein. Control logic 1170 may also include graphical user interface (GUI) logic to generate UIs associated with the methods sketch ranking method. Control logic 1170 specially programs computer device 1100 to perform efficient sketch ranking.

Control logic 1170 specially programs computer device 1100 to rank items by their aggregated values using operations that are more efficient than conventional computer operations. For example: operation 208 stores for later operational access only the highest/maximum-valued items (and their actual values) in memory efficient sketches, and ignores all other items and their values; operation 210 determines for each maximum-valued item a minimum aggregate value that can/would result from aggregating the values for the maximum-valued item across the multiple time intervals, without actually aggregating all of the values for the maximum-valued item across the multiple time intervals; operation 214 determines for each hash a respective maximum aggregate value that can/would result from aggregating the values for any item covered by the hash across the multiple time intervals, without actually aggregating all of the values of each item covered by the hash across all of the time intervals; and operation 222 eliminates from consideration hashes (and thus the items covered by the eliminated hashes) covering items that will contribute to a top-N ranking.

As specifically implemented, these aforementioned operations are necessarily rooted in computer technology to overcome a problem specifically arising in the realm of sorting information using a computer coupled with a network, namely, solving the problem of conventionally high computational burdens/complexities and memory storage requirements associated with performing a top-N ranking of items. The operations described herein can drastically reduce such computational burden/complexity and reduce associated memory storage requirements.

The memory also stores data 1180 used and generated by control logic 1170 as described herein. Data 1180 may include, associated with the host device 190, observation values for a variable. In some instances, the observation values are associated with a set of queries to a database (e.g., the database 192) made by the host device 190. Data 1180 includes information arranged in interval tables, interval sketches, a threshold ranking table, and a hash ranking table.

Examples of observation values of different types of observations values are provided below.

In some instances, each observation value is associated with a performance metric of the host device. In some instances, the performance metric is a per-query metric, i.e., associated with database performance on a per-query basis. Such metrics can include, but are not limited to:
a. mysql.queries.*.*.time_us—execution time for a MySQL query.
b. host.queries.*.*.affected_rows.tput—rate of affected rows.
c. host.queries.*.*.latency_us—query latency.
d. host.queries.*.*.time_us—execution time for a query.

In some instances, the performance metric is a per-query tag metric, i.e., associated with database performance based on the use of query tags. Such metrics can include, but are not limited to:
a. host.queries.tagged.*.*.affected_rows—rate of affected rows.
b. host.queries.tagged.*.*.latency_us—query latency.
c. host.queries.tagged.*.*.time_us—execution time for a query tag.

In some instances, the performance metric is a per-user metric, i.e., associated with database performance with respect to one or more users. Such metrics can include, but are not limited to:
a. host.users.*.*.created_tmp_tables.tput—rate of temporary tables created.
b. host.users.*.latency_us—query latency.
c. host.users.*.no_good_index.tput—rate of queries that did not use a good index.

In some instances, the performance metric is a SQL mutex metric, i.e., associated with performance of mutually exclusive locks, also termed mutexes. Using MySQL as an example, such metrics can include, but are not limited to:
a. mysql.mutex.innodb.*.count—count of InnoDB mutexes.
b. mysql.mutex.innodb.*.wait_us—wait time for InnoDB mutexes.

In some instances, the performance metric is a per-table metric, i.e., associated with database performance with respect to one or more tables. Using MySQL as an example, such metrics can include, but are not limited to:
a. mysql.tables.*.*.open.count, which provides an indication of the count of open tables.

In some instances, the performance metric is based on network socket(s) associated with the database. Such metrics can include, but are not limited to:
a. os.net.socket.port.*—OS port usage count.

In some instances, the performance metric is a per-database metric, i.e., associated with database performance of multiple databases. Such metrics can include, but are not limited to:
a. host.dbs.*.*.created_tmp_tables.tput—rate of temporary tables created.
b. host.dbs.*.*.lock time_us—lock time for a database.

In some instances, the performance metric is a per-process metric, i.e., associated with process performance on the host device 190. Such metrics can include, but are not limited to:
a. os.ps.*.count—number of instances of a process.
b. os.ps.*.fd_count—file descriptors for a process.
c. os.ps.*.sys_us—system CPU time for a process.
d. os.ps.*.syscalls_read—rate of read syscalls for a process.
e. os.ps.*.syscalls_write—rate of write syscalls for a process.
f. os.ps.*.user_us—user CPU time for a process.

In some instances, the performance metric is a process list metric, i.e., associated with performance of process lists. Using MySQL and postgreSQL (also sometimes known as pgSQL, or Postgres) as examples, such metrics can include, but are not limited to:
a. mysql.processlist.callers.*.count—number of MySQL process list callers.
b. 111361 mysql.processlist.callers.*.time_us—execution time of MySQL process list callers.
c. 111371 mysql.processlist.command.*.count—number of MySQL process list commands.
d. 111381 mysql.processlist.command.*.time_us—execution time of MySQL process list commands.

The embodiments presented herein include the following features:

Ranking with Multiple Columns

Instead of hashing a single column like query ID, multiple columns can be hashed. Considering multiple columns for grouping can increase the number of groups (items) exponentially. For example, you could have 1000 queries and 100 users, and the set of (query, user) groups have 10000 x100=1,000,000 elements.

Parallelization/Fan-Out

For parallelization/fan-out:
a. Parts of the above-described method may be parallelized and implemented with fan-out.
b. Each leaf in the fan-out may work on local data, the leaf just needs to get top hashes for its data.
c. The leaf can run in parallel since their work is independent.
d. The work within each leaf can also be parallelized since each hash is independent. So there is additional fan-out within each leaf.
e. This may be expressed in terms of MapReduce.

Lower Resource Use

Each leaf just sends top hashes back to the root, so there would be less data sent over a network.

Precomputation

Utilization precomputation strategies:
a. Sketch data can be precomputed so much of the data does not have to be retrieved from cold storage.
b. Without precomputation, the method employs two passes. The first pass gets the hashes, and the second pass does the final ranking. Precomputation would do the first pass ahead of time.

According to embodiments presented herein, a detection device performs sketch ranking. The detection device generates sketches, determine top hashes using the sketches, and queries data using the top hashes to prune unnecessary tuples. The sketch data is partitioned into separate time ranges. For each time range, there is a unique hash, the maximum value at that hash, and the item corresponding to that maximum value. During queries, the separate partitions of the sketch corresponding to different time ranges can be aggregated into a single sketch. Any entries with the same hash and item should be merged. In order to prune hashes, the detection device determines which hashes will not contribute to the final ranking. That means for a top-k ranking of the items, the data detection device determines the minimum aggregate value for the k^{th} item, and the maximum aggregate value for each hash. Both can be determined using the sketches. The minimum aggregate value for the k^{th} item sets the lower bound on what value each item in the top-k may have. The maximum aggregate value for a hash determines the maximum aggregate value any item within that hash can have. The goal is to prune hashes with maximum aggregate values less than the minimum aggregate value of the k^{th} item because it is impossible for any item within those hashes to have a high enough value to make it into the top-k. Once the top hashes are determined, the final ranking query can be performed.

In summary, in one form, a method is provided comprising, at a detection device:
a. assigning hashes to items that are uniquely identifiable so that each item maps to only one hash and each of at least some of the hashes covers multiple items;
b. for each time interval of multiple time intervals:
   i. receiving for each item a respective value of a variable associated with the item;
   ii. creating a respective interval table that maps each item to the respective value and the hash that covers the item; and
   iii. identifying for each hash a maximum-valued item as the item having a maximum value among all of the items covered by the hash, and creating a respective sketch that maps each hash to the maximum-valued item and the associated maximum value covered by that hash;
c. using the sketches, aggregating the per-interval (i.e., per sketch) maximum values for each maximum-valued item across the time intervals to produce an aggregate of maximum values for each maximum-valued item (which represents a minimum aggregate value that the item can have when all values for that item are aggregated across all time intervals), ranking the maximum-valued items according to their minimum aggregate values, and creating a threshold ranking table that maps, in ranking order, each maximum-valued item to the associated minimum aggregate value and the assigned hash;
d. using the sketches, aggregating all of the maximum values for all of the maximum-valued items covered by each hash across the time intervals (i.e., sketches), to produce a maximum aggregate value for each hash, ranking the hashes according to the maximum aggregate values, and creating a hash ranking table that maps, in hash ranking order, each hash to the associated maximum aggregate value;
e. pruning hashes, the pruning including selecting from the threshold ranking table a minimum aggregate value for a k^{th} item (i.e., a k^{th}-ranked one of the maximum-valued items) and pruning all hashes with maximum aggregate values less than the selected minimum aggregate value; and
f. ranking the top-k items only assigned to the hashes remaining after the pruning.

In another form, a sketch ranking method assign hashes to items and, for each of multiple time intervals: receives a respective value for each item; maps each item to the respective value and the hash that covers the item; identifies for each hash a maximum-valued item; and creates sketches mapping the hashes to their maximum-valued items and associated maximum values. Using the sketches, the method aggregates the per-interval maximum values for each maximum-valued item to produce a minimum aggregate value for each maximum-valued item; and aggregates all maximum values for all maximum-valued items covered by each hash across the time intervals, to produce a maximum aggregate value for each hash. To prune hashes, the method selects one of the minimum aggregate values and prunes all hashes having maximum aggregate values less than the selected minimum aggregate value. The method then ranks items assigned to the remaining hashes.

In yet another form, an efficient computer implemented method of ranking uniquely identifiable items associated with operating a host computer device over multiple time intervals is provided, comprising: assigning hashes to the items; for each time interval, receiving for each item a respective value of a variable associated with the item and that results from operating the host computer device during the time interval; for each time interval, identifying for each hash a respective maximum-valued item among the items covered by the hash as the item for which a maximum value is received; determining for each maximum-valued item a respective minimum aggregate value that would result from aggregating the values for the maximum-valued item across the multiple time intervals; determining for each hash a respective maximum aggregate value that can result from aggregating the values for any item covered by the hash across the multiple time intervals; selecting one of the minimum aggregate values as a threshold for eliminating hashes; eliminating each hash having a maximum aggregate value less than the threshold; and ranking a top-k items of the items based only on values for items covered by hashes remaining after the eliminating:

In another form, an apparatus to rank uniquely identifiable items associated with operating a host computer device over multiple time intervals is provided, comprising: a network interface unit to communicate with a network; and a processor coupled with the network interface unit and configured to: assign hashes to the items; for each time interval, receive for each item a respective value of a variable associated with the item and that results from operating the host computer device during the time interval; for each time interval, identify for each hash a respective maximum-valued item among the items covered by the hash as the item for which a maximum value is received; determine for each maximum-valued item a respective minimum aggregate value that would result from aggregating the values for the maximum-valued item across the multiple time intervals; determine for each hash a respective maximum aggregate value that can result from aggregating the values for any item covered by the hash across the multiple time intervals; select one of the minimum aggregate values as a threshold for eliminating hashes; eliminate each hash having a maximum aggregate value less than the threshold; and rank a top-k items of the items based only on values for items covered by hashes remaining after the eliminating.

In still another form, a non-transitory computer readable storage medium is provided. The medium is encoded with instructions that, when executed by a processor, cause the processor to perform an efficient method of ranking uniquely identifiable items associated with operating a host computer device over multiple time intervals, by: assigning hashes to the items; for each time interval, receiving for each item a respective value of a variable associated with the item and that results from operating the host computer device during the time interval; for each time interval, identifying for each hash a respective maximum-valued item among the items covered by the hash as the item for which a maximum value is received; determining for each maximum-valued item a respective minimum aggregate value that would result from aggregating the values for the maximum-valued item across the multiple time intervals; determining for each hash a respective maximum aggregate value that can result from aggregating the values for any item covered by the hash across the multiple time intervals; selecting one of the minimum aggregate values as a threshold for eliminating hashes; eliminating each hash having a maximum aggregate value less than the threshold; and ranking a top-k items of the items based only on values for items covered by hashes remaining after the eliminating.

The above description is intended by way of example only. Although the techniques are illustrated and described herein as embodied in one or more specific examples, it is nevertheless not intended to be limited to the details shown, since various modifications and structural changes may be made within the scope and range of equivalents of the claims.

What is claimed is:

1. An efficient computer implemented method of ranking uniquely identifiable items associated with operating a host computer device over multiple time intervals, comprising:
assigning hashes to the items;
for each time interval, receiving for each item a respective value of a variable associated with the item and that results from operating the host computer device during the time interval;
for each time interval, identifying for each hash a respective maximum-valued item among the items covered by the hash as the item for which a maximum value is received;
determining for each maximum-valued item a respective minimum aggregate value that would result from aggregating the values for the maximum-valued item across the multiple time intervals;
determining for each hash a respective maximum aggregate value that can result from aggregating the values for any item covered by the hash across the multiple time intervals;
selecting one of the minimum aggregate values as a threshold for eliminating hashes;
eliminating each hash having a maximum aggregate value less than the threshold; and
ranking a top-k items of the items based only on values for items covered by hashes remaining after the eliminating.

2. The method of claim 1, wherein the assigning includes assigning the hashes to the items that are uniquely identifiable such that each item maps only to one hash and each hash covers multiple items.

3. The method of claim 1, wherein the determining for each maximum-valued item the minimum aggregate value includes determining each minimum aggregate value without actually aggregating all of the values for the maximum-valued item across the multiple time intervals.

4. The method of claim 1, wherein the determining for each maximum-valued item the minimum aggregate value includes aggregating the maximum values for the maximum-valued item across the multiple time intervals, to produce an aggregate of maximum values for the maximum-valued item that represents the minimum aggregate value for the maximum-valued item.

5. The method of claim 1, wherein the determining for each hash the maximum aggregate value that would result from aggregating the values for any item covered by the hash across the multiple time intervals includes determining for each hash the maximum aggregate value without actually aggregating all of the values of each item covered by the hash across the multiple time intervals.

6. The method of claim 1, wherein the determining for each hash the maximum aggregate value includes aggregating the maximum values for the maximum-valued items covered by the hash, to produce the maximum aggregate value for the hash.

7. The method of claim 1, wherein the ranking the top-k items includes:
aggregating the values for each item covered by the hashes remaining after the eliminating across the multiple time intervals, to produce a respective total aggregated value for each of the top-k items; and
ordering the top-k items from high to low according to the total aggregate values for the top-k items.

8. The method of claim 1, wherein the selecting includes selecting the one of the minimum aggregate values as the threshold to eliminate hashes that cover items that will not contribute to the top-k items in the ranking.

9. The method of claim 8, further comprising, prior to the selecting:
ranking the maximum-valued items from low to high based on the minimum aggregate values for the maximum-valued items;
wherein the selecting includes selecting the minimum aggregate value for the k^{th} ranked maximum-valued item as the threshold; and
wherein the eliminating each hash based on the minimum aggregate value for the k^{th} ranked maximum-valued item ensures that the hashes remaining include at least the top-k items.

10. The method of claim 1, further comprising:
for each time interval, creating, and storing in memory, a respective sketch data structure that maps each hash to (i) the maximum-valued item for the hash, and (ii) the maximum value associated with the maximum-valued item.

11. The method of claim 10, wherein the determining for each maximum-valued item the minimum aggregate value, and the determining for each hash the maximum aggregate value, each include accessing information stored in the sketch data structures for the multiple time intervals.

12. The method of claim 1, further comprising:
storing in memory a threshold data structure to map each maximum-valued item to (i) the minimum aggregate value for the maximum-valued item, and (ii) the hash assigned to the maximum-valued item.

13. The method of claim 1, further comprising:
storing in memory a hash data structure to map each hash to the maximum aggregate value for the hash.

14. An apparatus to rank uniquely identifiable items associated with operating a host computer device over multiple time intervals, comprising:
a network interface unit to communicate with a network; and
a processor coupled with the network interface unit and configured to:
assign hashes to the items;
for each time interval, receive for each item a respective value of a variable associated with the item and that results from operating the host computer device during the time interval;
for each time interval, identify for each hash a respective maximum-valued item among the items covered by the hash as the item for which a maximum value is received;
determine for each maximum-valued item a respective minimum aggregate value that would result from aggregating the values for the maximum-valued item across the multiple time intervals;
determine for each hash a respective maximum aggregate value that can result from aggregating the values for any item covered by the hash across the multiple time intervals;
select one of the minimum aggregate values as a threshold for eliminating hashes;
eliminate each hash having a maximum aggregate value less than the threshold; and
rank a top-k items of the items based only on values for items covered by hashes remaining after the eliminating.

15. The apparatus of claim 14, wherein the determining for each maximum-valued item the minimum aggregate value includes determining each minimum aggregate value without actually aggregating all of the values for the maximum-valued item across the multiple time intervals.

16. The apparatus of claim 14, wherein the determining for each maximum-valued item the minimum aggregate value includes aggregating the maximum values for the maximum-valued item across the multiple time intervals, to produce an aggregate of maximum values for the maximum-valued item that represents the minimum aggregate value for the maximum-valued item.

17. The apparatus of claim 14, wherein the determining for each hash the maximum aggregate value that would result from aggregating the values for any item covered by the hash across the multiple time intervals includes determining for each hash the maximum aggregate value without actually aggregating all of the values of each item covered by the hash across the multiple time intervals.

18. A non-transitory computer readable medium encoded with instructions that, when executed by a processor, cause the processor to perform an efficient method of ranking uniquely identifiable items associated with operating a host computer device over multiple time intervals, by:
assigning hashes to the items;
for each time interval, receiving for each item a respective value of a variable associated with the item and that results from operating the host computer device during the time interval;
for each time interval, identifying for each hash a respective maximum-valued item among the items covered by the hash as the item for which a maximum value is received;
determining for each maximum-valued item a respective minimum aggregate value that would result from aggregating the values for the maximum-valued item across the multiple time intervals;
determining for each hash a respective maximum aggregate value that can result from aggregating the values for any item covered by the hash across the multiple time intervals;
selecting one of the minimum aggregate values as a threshold for eliminating hashes;
eliminating each hash having a maximum aggregate value less than the threshold; and
ranking a top-k items of the items based only on values for items covered by hashes remaining after the eliminating.

19. The non-transitory computer readable medium of claim 18, wherein the instructions to cause the processor to perform the determining for each maximum-valued item the minimum aggregate value include instructions to cause the processor to perform determining each minimum aggregate value without actually aggregating all of the values for the maximum-valued item across the multiple time intervals.

20. The non-transitory computer readable medium of claim 18, wherein the instructions to cause the processor to perform the determining for each hash the maximum aggregate value that would result from aggregating the values for any item covered by the hash across the multiple time intervals include instructions to cause the processor to perform determining for each hash the maximum aggregate value without actually aggregating all of the values of each item covered by the hash across the multiple time intervals.
